(19) United States
(12) Patent Application Publication
(10) Pub. No.: US 2024/0426331 A1
(43) Pub. Date: Dec. 26, 2024

(54) CONNECTION SOCKET AND CONNECTOR

(71) Applicant: PERI SE, Weissenhorn (DE)

(72) Inventors: Philipp Rusch, Weissenhorn (DE); Andreas Spiegl, Weissenhorn (DE); Guenther Staudenrausch, Weissenhorn (DE)

(73) Assignee: PERI SE, Weissenhorn (DE)

(21) Appl. No.: 18/700,841

(22) PCT Filed: Sep. 1, 2022
(86) PCT No.: PCT/EP2022/074339

§ 371 Date: Apr. 12, 2024

(30) Foreign Application Priority Data
Oct. 13, 2021 (DE) 10 2021 126 516.9

(51) Int. Cl. F16B 5/06

(52) U.S. Cl. CPC F16B 5/0621

(57) ABSTRACT

A connection socket for use in a connector, having a casing which extends along a connection axis at least in some regions and which extends in the circumferential direction about the connection axis at least in some regions, a base region which is connected to the casing or is part of the casing and which extends perpendicular to the connection axis at least in some regions, said base region delimiting the connection socket in the direction of the connection axis on one side. The connection socket further comprises at least one securing element, at least one pressure surface which extends radially to the connection axis, and at least one undercut which forms a cavity in the interior of the casing. A connector with a connection socket, and to a double plate secured using at least one connector. A method for securing two plates to a support.

### FIELD OF THE INVENTION

The invention relates to a connection socket for use in a connector comprising:

a casing which extends along a connection axis at least in some regions and which extends in the circumferential direction about the connection axis at least in some regions,

a base region which is connected to the casing or is part of the casing and which extends perpendicular to the connection axis at least in some regions, said base region delimiting the connection socket in the direction of the connection axis on one side. The connection socket further comprises at least one securing element, at least one pressure surface which extends radially to the connection axis, and at least one undercut which forms a cavity in the interior of the casing. The invention further relates to a connector with a connection socket, as well as a double plate secured using at least one connector. The invention finally also relates to a method for securing two plates to a support.

### BACKGROUND

In various technical applications, plates are placed on an underlying frame construction to produce a surface. The plates may be, for example, wooden plates or plastic plates having a functional surface facing away from the underlying frame construction. The entire structure serves to provide for such a functional surface. Such a functional surface may be, for example, the cargo floor of a truck. In this case, the functional surface has to be stable and wear resistant. Another application of a structure in which plates having a functional surface are placed on a frame construction are formwork panels used for applying formwork to building parts. In this case, the plates have a functional surface which has to be implemented so that it is impermeable to liquid concrete material used for producing the building parts. In addition, the functional surface should be removable from the building parts in an easy manner after the production of the building parts to which end water-or concrete-repellent properties are required. It is common to these and other applications that the functional surface is subject to wear in use and that it has to be exchanged or replaced from time to time to ensure the perpetuation of its properties. For this purpose, in prior art, the plates providing for the functional surface are usually removed from the underlying frame construction and completely exchanged. This complete replacement is elaborate and cost-intensive.

### SUMMARY

The object of the invention is therefore the proposal of solutions with the aid of which a functional surface on a plate secured to an underlying frame construction can be exchanged or replaced in a facilitated manner.

This object is solved by a connection socket for use in a connector comprising:
a casing, which extends along a connection axis at least in some regions and which extends in the circumferential direction about the connection axis at least in some regions, a receptacle being disposed in the interior of the casing,
a base region which is connected to the casing or is part of the casing and which extends perpendicular to the connection axis at least in some regions, the base region delimiting the connection socket in the direction of the connection axis on one side,
at least one securing element which is disposed on or in the casing or on or in the base region,
at least one pressure surface which extends in the radial direction to the connection axis, the pressure surface forming a front surface of the connection socket in the direction of the connection axis or projecting beyond the front surface of the connection socket disposed on the base region in the radial direction to the connection axis,
at least one undercut which forms a cavity in the interior of the casing, the undercut being delimited by elements of the connection socket projecting in the radial direction to the connection axis and adjoining the undercut on two opposite sides in the direction of the connection axis, and the undercut being open in the radial direction to the connection axis in some regions.

A connection socket according to the invention is preferably provided for the use in a connector for providing a secured double plate. The connection socket is a securing element and a connecting element.

The connection socket according to the invention extends along an imaginary connection axis defining the direction in which the connection socket can be connected to another connecting element, for example, a connecting plug. The connection axis is also the direction in which the connection axis can be separated from another connecting element, for example, a connecting plug. The connection socket comprises a casing which delimits the connection socket towards the outside. The connection axis is located in the interior of the casing, the casing extending in the direction of the connection axis. Incidentally, the casing, at least in sections, surrounds the connection axis. Preferably, the casing completely encloses the connection axis in the circumferential direction. However, it is also possible that the casing only partly encloses the connection axis and particularly has interruptions in the circumferential direction. In the interior of the casing, a receptacle is disposed which forms a hollow interior space there. The receptacle is provided for accommodating another connecting element which is connected to the connection axis. The connection socket according to the invention further comprises a base region which is connected to the casing. Alternatively, the base region may also be part of the casing. In any case, the base region, at least in sections, extends perpendicular to the connection axis. Incidentally, the base region is a delimitation of the connection socket delimiting it on one side as viewed in the direction of the connection axis. The connection socket and/or the casing is open on the side opposite of the base region in the direction of the connection axis. Through this open side, the receptacle in the interior of the casing can be accessed. The connection socket further comprises at least one securing element. The securing element may have various designs. In a simple case, the securing element may be formed by a mounting aperture into which an additional mounting component for securing the connection axis is introduced. Alternatively, the securing element may also be formed by a thread disposed on the connection socket. It is further possible that the securing element is formed by a bolt or pin provided for the connection to another component in press fit. Other embodiments of the securing element are also possible. The securing element is provided for securing the connection axis to another component, for example, a plate or a support. The securing element may be disposed in various positions on the connection socket, for example, in or on the casing or in or on the base region. The connection socket according to the invention further comprises a pressure surface which extends in the radial direction to the connection axis. An extension in the radial direction to the connection axis is to be understood to mean that the projection of the pressure surface along the connection axis projects beyond the connection axis in a plane perpendicular to the connection axis. To this end, for example, the pressure surface may be disposed perpendicular to the connection axis. Moreover, however, the pressure surface may also be oriented so that it is inclined with respect to the connection axis. In this case, one component of the pressure surface extends perpendicular to the connection axis, and another component parallel to the connection axis. As long as one component of the pressure surface extends perpendicular, i.e. radially to the connection axis it is defined that the pressure surface extends in the radial direction to the connection axis. The pressure surface, at least in sections, delimits the connection socket in a direction parallel to the connection axis. For example, the pressure surface may form a front surface of the connection socket in the direction of the connection axis. Alternatively, the pressure surface may be disposed adjacent to the base region or adjacent to the casing and project beyond the base region and the casing towards the outside in the radial direction. Finally, the connection socket according to the invention comprises at least one undercut which forms a cavity in the interior of the casing. The undercut is delimited by other, adjoining elements of the connection socket on two of its opposite sides in the direction of the connection axis so that the undercut is not accessible in the direction of the connection axis. The undercut is therefore delimited in a direction parallel to the connection axis, particularly delimited by elements of the casing. However, in the radial direction to the connection axis, the undercut, at least in sections, is designed so that it is open. Here, the open side of the undercut is preferably oriented towards the receptacle in the casing.

The connection socket according to the invention is capable of assuming two different functions in connecting structural elements, for example plates. On the one hand, the connecting sleeve is capable of forming part of a two-part connector. Such a connector will be described later. The connecting sleeve can be reversibly connected to and separated from another part of the connector when used in the connector. In this way, a detachable function is given which renders an easy exchange of structural elements such as, for example, plates possible. The connection socket may be used, for example, to detachably fix a plate having a functional surface on an underlying frame construction or support. As a second important function, the connection socket according to the invention can be used separately, i.e. without a second part of a connector, for securing a structural element, for example a plate, on a frame construction or on a support. Here, the connection socket is mechanically interposed between the structural element and the frame construction. This means that, in such a connection, the flow of forces is guided from the structural element, for example a plate, to the connection socket and from the connection socket through its securing element to the support or to the frame construction. Here, the pressure surface of the connection socket provides for a sufficiently large contact surface between the connection socket and the structural element which results in a lower surface pressure between the two components when mounted. In this way, a long-term stable, material-friendly connection between the connection socket and the structural element is ensured. In this connection, the connection socket is connected to a support or a frame construction by its securing element. In this attachment, the connection socket has an effect similar to a washer in a screw connection: the connection socket enlarges the contact surface through which a structural element is non-positively clamped to a frame construction or a support. With this enlargement of the contact surface as compared to a direct connection via a mounting component disposed between the structural element and the support, the safety of the connection is significantly increased. The surface pressure of the connection is reduced so that the mechanical load on the structural element in the mounting area is reduced. The reduction of this load renders the connection more stable, particularly more long-term stable, even in case of dynamic loads. Particularly advantageous in the connection socket according to the invention is the simultaneous provision of a pressure surface and a receptacle comprising an undercut. Owing to these two subsections or components of the connection socket, it can be used to significantly facilitate the exchange of a functional surface on an underlying frame construction. Here, the connection socket, on the one hand, renders a long-term stable attachment of a load-bearing base plate to the frame construction possible, and, on the other hand, enables an easy and easily detachable attachment of a cover plate to the base plate, the provision of the cover plate with a functional surface being possible. At the same time, the connection socket according to the invention has a simple design and can therefore be produced at low cost.

In one embodiment of the connection socket, it is contemplated that at least one insertion surface is provided which extends in the radial direction to the connection axis and is, at least in sections, inclined with respect to the connection axis, and which is oriented towards the side of the connection socket facing away from the base region in the direction of the connection axis. In this embodiment, the connection socket has an insertion surface provided as an insertion surface for the facilitated insertion of a second part of a connector, for example, a connecting plug. The insertion surface acts as an insertion slope. At least one component of the insertion surface extends in the radial direction to the connection axis. Here, the insertion surface, at least in sections, is also inclined with respect to the connection axis and may be oriented, for example, at an angle of 45° to the connection axis. Here, the insertion surface may completely enclose the connection axis or only be disposed around the connection axis in the circumferential direction in sections. Preferably, the insertion surface has a conical or curved design.

Preferably, it is contemplated that the casing has a casing surface oriented away from the connection axis which, at least in sections, has a cylindrical configuration and extends parallel to the connection axis. In this embodiment, the casing has a cylindrical shape on the outside. Owing to this design, an introduction into a readily producible, cylindrically shaped recess in a structural element, for example a plate, is rendered possible.

In one embodiment, it is contemplated that the casing has a casing surface oriented away from the connection axis which forms the pressure surface, the pressure surface, at least in sections, preferably having conical or spherical design. In this embodiment, the casing, at least in sections, has no cylindrical design but a shape having at least one component which extends radially away from the connection axis and therefore forms the pressure surface. To this end, the outer side of the casing, at least in sections, may have the shape of a cone the side of which having the smaller diameter is oriented towards the base region. In this embodiment, a large pressure surface is provided. Alternatively, the area of the outer casing surface implemented as the pressure surface may also be designed so that it is curved or spherical, the diameter of the pressure surface perpendicular to the connection axis being smaller on its side facing the base region than on its side facing away from the base region.

In another embodiment, it is contemplated that the casing has a casing surface oriented away from the connection axis, and that the pressure surface projects beyond the casing towards the inside or towards the outside in the radial direction to the connection axis. In this embodiment, the pressure surface is implemented so that it projects relative to a surface of the casing in the radial direction to the connection axis. Here, the pressure surface may project beyond the outer surface of the casing towards the outside in the radial direction or project beyond the inner surface of the casing towards the inside in the radial direction. In the direction of the connection axis, in other words, in the direction of the height of the connection socket, the pressure surface may be disposed in various positions here. The inclination of the pressure surface with respect to the connection axis may also be implemented differently.

In another embodiment, it is contemplated that the pressure surface is formed by a surface of the base region oriented perpendicular to the connection axis. In this embodiment, the pressure surface is disposed on the base region. The pressure surface may extend across the entire surface of the base region facing away from the receptacle or also only across a subsection of the same. It is advantageous in this embodiment that the pressure surface has a large surface area.

In another embodiment, it is contemplated that the pressure surface is disposed on a collar, the collar being disposed on an outer surface of the casing facing away from the connection axis and extending in a direction radially away from the connection axis. In this embodiment, a collar on which the pressure surface is located is disposed on the outside of the casing. In this embodiment, the pressure surface is therefore located outside of the outer diameter of the casing. Here, the collar may be disposed, for example, on the side of the casing facing away from the base region. Preferably, the collar extends completely around the connection axis in the circumferential direction. Alternatively, however, the collar may also only be disposed around the connection axis in the circumferential direction in sections. For example, the collar may project towards the outside beyond the outer surface of the casing in the radial direction in an area of 1 mm to 20 mm.

Furthermore, it is contemplated that the pressure surface is disposed on a side of the collar facing the base region and oriented perpendicular to the connection axis or at an acute angle to the connection axis in a direction away from the base region. In this embodiment, the pressure surface is disposed on the lower side of the collar. Here, the pressure surface may be oriented perpendicular to the connection axis. In this case, the pressure surface preferably extends perpendicular to the outer surface of the casing. Alternatively, the pressure surface may also be oriented at an acute angle of zero to 90° to the connection axis. Such a pressure surface oriented at the acute angle to the connection axis preferably has a conic design and has a centring effect similar to the lower portion of the head a countersunk screw when the connecting sleeve is mounted in a structural element, for example, a plate.

Furthermore, is possible that the collar adjoins the casing on its side disposed opposite of the base region in the direction of the connection axis. In this embodiment, the collar is disposed on the side of the casing facing away from the base region. Alternatively, the collar may also be disposed on the side facing the base region or between the side facing the base region and the side of the casing facing away from the base region in the direction of the connection axis.

In another embodiment, it is contemplated that the base region is formed by a front surface of the casing. In this embodiment, the base region is part of the casing and is formed by a front surface or a subsection of the front surface of the casing.

It is also possible that the base region, starting from the casing, extends radially towards the connection axis and delimits the receptacle in the interior of the casing. In this embodiment, the base region is formed by a subsection of the connecting sleeve other than the casing. The base region extends from the surrounding casing radially inwards to the connection axis. Here, the base region may completely close the casing on one side of the connection socket in the direction of the connection axis. Alternatively, openings extending along the connection axis may also be provided in the base region. In this embodiment, the base region delimits the receptacle in the interior of the casing together with the casing.

Skilfully, it is contemplated that the casing, at least in sections, is designed so that it is rotationally symmetrical to the connection axis. In this embodiment, at least one subsection of the casing is formed and positioned so that it is rotationally symmetrical to the connection axis. Such a subsection is particularly stable and, at the same time, producible in a simple way and connectable to a connecting plug.

In a preferred implementation, it is contemplated that the casing is defined by a rectangle, triangle, trapezoid, or polygon spaced apart from the connection axis which defines the three-dimensional casing when rotated about the connection axis. In this embodiment, the casing is designed so that it is completely rotationally symmetrical to the connection axis. The casing may be described by a cross section in the form of a rectangle, triangle or having another cross-sectional shape being rotated about the connection axis. This rotation defines a three-dimensional body which forms the casing.

In another embodiment, it is contemplated that the casing, in a plan view, has a circular inner surface and/or outer surface parallel to the connection axis. In this embodiment, the casing is designed as a circular cylinder which has a likewise circular cylinder-shaped cavity in its interior. In a plan view parallel to the connection axis, the casing has a circular cylinder-shaped cross section. In this way, the receptacle in the interior of the casing obtains a circular cylinder-shaped form. This design is particularly favourable since a connection to a connecting plug can be equally established in any angular orientation about the connection axis.

Furthermore, it is contemplated that the base region or a front surface of the base region is oriented perpendicular to the connection axis. Such an orientation of the front surface or another surface on the base region may be used, for example, as a pressure surface. With an orientation perpendicular to the connection axis in the mounted state, a particularly uniform pressure transfer between the connection socket and another structural element, for example a plate, is rendered possible.

In another embodiment, it is contemplated that the securing element is implemented as a mounting aperture which extends through the base region and is disposed so that it is coaxial to the connection axis. In this simple embodiment, the securing element is formed by an opening allowing for passing through a mounting component, for example, a screw. With a coaxial positioning of this mounting aperture with respect to the connection axis, a symmetrical transfer of forces between the connection socket and an adjoining structural element, for example a plate, is rendered possible.

In another embodiment, it is contemplated that the securing element is implemented as a mounting aperture which extends through the casing, and which particularly extends parallel to the connection axis. In this embodiment, the securing element implemented as a mounting aperture is not disposed in the base region but in the casing. Preferably, a plurality of mounting apertures is disposed in regular intervals around the connection axis in the casing. In this way, it is possible to secure the connecting sleeve to another structural element, for example, a plate via a plurality of mounting components. In this embodiment, the base region is preferably formed by a front surface of the casing.

Optionally, it is contemplated that the securing element is implemented as a mounting aperture, and that a force introduction surface oriented perpendicular or at an angle of 90° to 10° to the direction of extension of the securing element is disposed adjacent to the securing element. In this embodiment, a force introduction surface is disposed adjacent to a securing element implemented as a mounting aperture. Preferably, the shape and the orientation of the force introduction surface correspond to the shape of a head of a mounting component, for example, a screw. When a countersunk screw is to be used as the mounting component the force introduction surface is oriented so that it flatly abuts on the conically shaped head of the countersunk screw. When, on the other hand, a screw having a flat head is to be used as the mounting component the force introduction surface has a planar design and extends perpendicular to the direction of extension of the mounting aperture. The base region or the casing may, in addition, be implemented so that it is reinforced adjacent to the force introduction surface, for example, by an increased wall thickness, or also by an insertion element made of, for example, metal. In this way, the transfer of forces between a mounting component and the connection socket is improved.

In an alternative embodiment, it is contemplated that the securing element is implemented as a male thread which is disposed on an outer surface of the casing facing away from the connection axis. In this embodiment, the securing element is disposed on the outer side of the casing. By means of a male thread disposed there, the connection socket can be screwed into a female thread in another structural element formed so that it is, correspondingly, complementary in shape. Advantageous in this solution is that no additional mounting component is required. Alternatively, a male thread may also be disposed on a subsection of the base region projecting in the direction of the connection axis and serve as a securing element.

Furthermore, it is contemplated that the undercut is disposed on the inner side of the casing oriented towards the connection axis and forms a subsection of the receptacle. The undercut forms a subsection of the receptacle and is disposed in the casing. Preferably, the undercut extends around the connection axis along the inner side of the casing in the circumferential direction.

In another embodiment, it is contemplated that the undercut is disposed between the base region and the end of the casing facing away from the base region in the direction of the connection axis. In this embodiment, the undercut is disposed between the base region and the end of the casing facing away from the base region. Therefore, the undercut is disposed on the outer edge of the receptacle facing away from the connection axis.

Preferably, it is contemplated that the undercut has at least one support surface which is oriented at an acute angle to a plane perpendicular to the connection axis on its side facing away from the base region in the direction of the connection axis. This support surface is provided so that, in the connected state in which the connection socket is connected to a connecting plug, a corresponding counter surface, for example, a fixation surface of the connecting plug abuts on the support surface. The fixation of the connection socket on the connecting plug is established by this abutment of the two surfaces. The support surface is a sub-surface of the undercut and is disposed at an acute angle relative to a plane perpendicular to the connection axis. Here, the support surface is located on the side of the undercut facing away from the base region. The support surface is preferably formed so that it is complementary in shape to an associated fixation surface of a connecting plug.

In an alternative embodiment, it is contemplated that a connecting protrusion is provided which, starting from the base region, projects into the receptacle in the interior of the casing in the direction of the connection axis, and that the undercut and/or the insertion surface are disposed on this connecting protrusion. In the embodiments described above, the undercut and the insertion surface are disposed on, in, or directly adjacent to the casing. In this alternative embodiment, a connecting protrusion is provided which is surrounded by the casing and secured to the base region. This connecting protrusion projects into and is surrounded by the receptacle. Here, the connecting protrusion is preferably surrounded by the casing over its entire length. On this connecting protrusion, the undercut and/or the insertion surface may be disposed. For example, the undercut may be disposed on the connecting protrusion directly adjacent to the base region. Such an undercut is delimited by the base region on the one side, and by a portion of the connecting protrusion protruding towards the connection axis in the radial direction on an opposite side in the direction of the connection axis. The insertion surface may be disposed adjacent to such an undercut in the direction of the connection axis. In this alternative embodiment, the two functional areas, the undercut and the insertion surface, are disposed in the interior the receptacle. In this way, the casing can be used for other functions, for example, as a pressure surface or as a base for the securing element. In this alternative embodiment, of course, an associated connecting plug also has to be formed so that it is different from a connecting plug which is used for the connection to a connection socket according to one of the embodiments in which the undercut and the insertion surface are disposed on the casing.

Skilfully, it is contemplated that the securing element is implemented as a mounting aperture and extends through the connecting protrusion. In this embodiment, a securing element implemented as a mounting aperture extends through the connecting protrusion. Preferably, the connection opening is disposed so that it is coaxial to the connection axis in this embodiment as well.

Furthermore, it is contemplated that the connecting protrusion is disposed so that it is coaxial to the connection axis. Due to such a coaxial arrangement, the functional areas, the undercut and/or the insertion surface, and the connection axis are disposed in one line. In this way, the flow of forces through the connection socket is guided on a short path in the state connected to a connecting plug so that the connection is stable and flexurally rigid.

In another embodiment, it is contemplated that, in a plan view from the direction of the connection axis, the receptacle is disposed between the casing and the connecting protrusion and particularly implemented in a ring shape and encloses the connecting protrusion. Such a ring-shaped design of the receptacle around the connecting protrusion facilitates the combination of the connection socket with a connecting plug. Preferably, the connection socket according to this embodiment is designed so that it is rotationally symmetrical about the connection axis.

Advantageously, it is contemplated that the undercut is open on a side facing the connection axis or facing away from the connection axis. The undercut, at least in sections, is open in the radial direction to the connection axis to render the introduction of a subsection of a connecting plug possible in the connected state. Depending on the embodiment of the undercut, it may be implemented so that it is open on its side facing the connection axis, particularly when the undercut is disposed on or in the casing. Alternatively, the undercut may also be implemented so that it is open on its side facing away from the connection axis, particularly in the case in which the undercut is disposed on or in a connecting protrusion which extends in the interior of the receptacle.

Skilfully, it is contemplated that the distance between the edge of the insertion surface facing away from the base region and the inner surface of the casing in a direction perpendicular to the connection axis is larger than the distance between the edge of the insertion surface facing the base region and the inner surface of the casing in a direction perpendicular to the connection axis. These features of the insertion surface define its inclination or orientation. The insertion surface is to act like an insertion slope and to facilitate the introduction of a connecting plug into the connection socket. The insertion surface is disposed on the edge of or adjacent to the receptacle. The opening width or the inner diameter of the insertion surface is always larger on its edge facing away from the base region than its opening width or inner diameter on its edge facing the base region. In this way, the insertion surface is inclined so that its inner diameter decreases towards the base region in a direction parallel to the connection axis. In this way, an introduction of the connecting plug into the interior of the casing, particularly into the receptacle, is guided and therefore facilitated.

In one embodiment, it is contemplated that the insertion surface, at least in sections, is formed so that it is conical, spherical, or curved. Such a design facilitates the insertion of a connecting plug into the connection socket and, in the process, centres the connecting plug with respect to the connection axis.

Advantageously, it is contemplated that the insertion surface surrounds the connection axis and is particularly ring-shaped in a plan view from the direction of the connection axis. In this embodiment, the insertion surface is disposed around the connection axis in a closed manner. In this way, it is ensured that the insertion surface will always contact an inserted connecting plug, particularly in all possible rotational orientations about the connection axis. Of course, it is also possible that the insertion surface is disposed around the connection axis in the circumferential direction only in sections.

In another embodiment, it is contemplated that the insertion surface and the support surface of the undercut are disposed adjacent to each other and particularly connected to each other by a rounded transition area. It is favourable that the insertion surface and the support surface of the undercut are disposed adjacent to each other or so that they adjoin. Preferably, a rounded transition area is disposed between the insertion surface and the support surface. When the connection is established, a connecting plug inserted into the connection socket is first guided by the insertion surface, will then slide over the rounded transition area, and will then, at least in sections, abut on the support surface. Owing to this design, the connecting force for establishing the connected state of the connection socket and the connecting plug can be reduced.

Skilfully, it is contemplated that the support surface, at least in sections, is implemented so that it is planar or conical. For ensuring a high retaining force between the connection socket and a connecting plug in the connected state, an extensive abutment between the support surface and a surface, for example, a fixation surface on the connecting plug is important. Such an extensive abutment can be achieved particularly well by a support surface having a planar or conical design. Such a shape of the support surface can be produced in an easy manner.

Advantageously, it is contemplated that the connection socket is made of a plastic material and implemented in one piece. In this embodiment, the connection socket can be readily produced in large quantities at low cost, for example, by injection moulding. Here, the plastic material used for manufacturing may be fibre-reinforced to obtain higher rigidities. Of course, the connection socket may also be made of another material, for example, a metallic material.

The object of the invention is also solved by a connector comprising a connection socket according to one of the embodiments described above and a connecting plug, the connecting plug comprising:
a base which carries the other elements of the connecting plug,
at least one bending portion which comprises at least one elastically deformable bending arm, the bending arm, starting from the base, extending parallel to a plug axis,
at least one interior bending space which, at least in sections, is enclosed by the bending portion, and which is implemented so that it is open on its side facing away from the base in the direction of the plug axis, and the plug axis (SA) extending through the interior bending space,
   the bending arm comprising a bending element connected to the base which is designed so that it is elastically deformable in a radial direction to the plug axis, and the bending arm comprising a latching element which is connected to the bending element on its side facing away from the base, the latching element having a protrusion which projects beyond the bending element in the radial direction to the plug axis, and the latching element having at least one mating surface which extends in the radial direction to the plug axis and, at least in sections, is inclined with respect to the plug axis, and which is oriented towards the side of the connecting plug facing away from the base in the direction of the plug axis;
   the bending portion of the connecting plug, at least in sections, being introduced into the receptacle of the connection socket in a connected state of the connector, the protrusion of the latching element, at least in sections, being introduced into and positively connected to the undercut, and the fixation surface abutting on the support surface.

A connector according to the invention comprises a connection socket as well as, as an associated counterpart, a connecting plug reversibly connectable to the connection socket. Here, reversible is to be understood to mean that the connection between the connection socket and the connecting plug can be repeatedly established and separated. In the process, neither the connection socket nor the connecting plug is damaged or destroyed. The connector according to the invention may be used, for example, to connect two plates to each other and to, at the same time, secure them to a support or a frame construction.

The connecting plug of the connector comprises a base which carries the other elements of the connecting plug, particularly the bending portion. A bending portion is fixedly connected to the base and comprises at least one elastically deformable bending arm. Preferably, a plurality of bending arms is provided. The bending arm extends parallel to a plug axis from the base. Here, the plug axis is to be understood to be an imaginary axis defining a direction in which the connecting plug can be introduced into and pulled out of a connection socket. The connecting plug further comprises an interior bending space which, at least in sections, is enclosed by the bending portion. The interior bending space serves to accommodate the elastically deformed bending arm in the connected state. Such an elastic deformation of the bending arm occurs during the connection to a connection socket when the connecting plug and the connection socket are connected to each other. Here, the elastic deformation of the bending arm produces a return force in the bending arm which results in a non-positive and positive connection in the connector. The bending arm comprises a bending element connected to the base which is elastically deformable in a radial direction to the plug axis. The bending element is preferably formed in the manner of a bending beam. Moreover, the bending arm comprises a latching element which is disposed on the side of the bending element facing away from the base. Preferably, the latching element is not elastically deformed during a connection to a connection socket. The latching element, at least in sections, becomes engaged in the undercut in the connection socket in the connected state. The latching element has a protrusion which projects beyond the bending element in the radial direction to the plug axis. This protrusion forms the subsection of the bending arm which is introduced into the undercut of the connection socket in the connected state. Moreover, a mating surface which, similar to the insertion surface on the connection socket, facilitates the combination and introduction of the connecting plug and the connection socket into each other is disposed on the latching element. The mating surface extends in the radial direction to and is inclined with respect to the plug axis. For rendering a symmetrical, non-positive connection of the connecting plug to a connection socket possible, preferably, a plurality of bending arms is disposed in regular intervals around the plug axis. In a connected state in which the connecting plug is connected to the connection socket the bending portion, at least in sections, is introduced into the receptacle. The protrusion of the latching element is located in the undercut in the connected state. Here, a fixation surface disposed on the side of the protrusion facing the base abuts on the support surface in the undercut of the connection socket. Owing to this abutment of the fixation surface on the support surface, also a positive connection of the connecting plug to the connection socket is given in the connected state.

A connector according to the invention is capable of reversibly connecting two structural elements, for example, two plates to each other. The connector can be attached to and connected to and detached from the structural elements in an easy manner by applying a force parallel to the connection axis or parallel to the plug axis. Here, the connector can be connected and separated without a tool. In this way, such a connection is particularly easy to handle. Apart from its property as part of the connector, the connection socket may provide for the additional function of fixing a structural element, for example a plate, on a support or a frame construction. The connector according to the invention therefore facilitates the exchange of a functional surface on a plate attached to an underlying frame construction.

In one embodiment of the connector, it is contemplated that the latching element comprises the fixation surface which, at least in sections, has a planar or conical design on its side facing away from the mating surface in the direction of the plug axis. In this embodiment, the fixation surface is disposed on the latching element and may also extend outside of the protrusion. The fixation surface is disposed on the latching element on a side opposite of the mating surface. Here, the fixation surface faces the base.

In another embodiment, it is contemplated that the base is detachably connected to an adapter, the base, at least in sections, being positively introduced into a recess disposed in the adapter, and that the connection between the base and the adapter can be established and released by shifting the base relative to the adapter in a direction perpendicular to the plug axis. In this embodiment, the connector further comprises an adapter which is a connecting member between a structural element, for example a plate, and the connecting plug. When the connecting plug is attached to a structural element the adapter is first secured on or in the structural element. Then, the connecting plug is positively connected to the adapter. The provision of this adapter facilitates the replacement of the connecting plug in a case in which it becomes worn or damaged. In the adapter, a recess having at least one undercut is disposed into which the base of the connecting plug, at least in sections, is inserted. This insertion of the connecting plug into the adapter takes place in a direction oriented perpendicular to the plug axis. An exchange of the connecting plug in the adapter is therefore possible by means of a simple, linear movement. No tool is required for introducing and removing the connecting plug. Preferably, the entire connector is configured so that wear which will inevitably occur after repeatedly connecting and separating the connector will predominantly occur on the connecting plug. Due to the fact that the connecting plug is readily exchangeable owing to the arrangement in the adapter the entire connector can therefore be quickly and easily revised after having been repeatedly used by just replacing the connecting plug. The connection socket is designed so that wear hardly occurs on it and is therefore designed for a higher number of connecting cycles than the connecting plug.

Furthermore, it is contemplated that the plug axis forms the central axis of the bending portion. In this embodiment, the bending portion is disposed around the plug axis. This results in a symmetrical structure of the connecting plug which is favourable for a reliable and stable transfer of forces between the connecting plug and the connection socket.

In another embodiment, it is contemplated that the base extends away from the bending arm towards the outside in a radial direction to the plug axis, and that the base has at least one mounting area which is particularly implemented as an opening, a male thread, or a mounting pin. In this embodiment, the connecting plug is not provided to be connected to a structural element via an adapter. Instead, the base has a mounting area which is provided for directly securing the connecting plug on a structural element, for example, a plate. This mounting area may be implemented, for example, as an opening through which a mounting component such as a screw can be passed. Alternatively, the mounting area may also be implemented, for example, as a male thread which is screwed into an associated female thread on the structural element. The mounting area may also have another design, for example, as a mounting pin which can be driven into a structural element like a nail for establishing a non-positive and positive connection of the connecting plug.

Advantageously, it is contemplated that the mating surface, at least in sections, has a curved or rounded design. During a connection of the connecting plug to the connection socket, the mating surface preferably slides along the insertion surface. It has been found that a curved or rounded shape of one of the two surfaces is capable of reducing the connecting force required for introducing the connecting plug into the connection socket. For example, the mating surface may therefore have a rounded or curved design. Alternatively, also the insertion surface on the connection socket may have a rounded or curved design.

It is contemplated that, in the connected state, the bending element is elastically deformed as compared to a non-connected state so that a non-positive connection is established between the bending arm and the receptacle, particularly the undercut. In the connected state, the bending element is elastically deformed so that a return force directed in a radial direction to the connection axis and to the plug axis is generated in the bending element by the deformation. This return force pushes the bending arm in the direction of the undercut, and therefore the latching element is pushed into the undercut. In this way, both a non-positive and a positive connection are established between the connection socket and the connecting plug.

Preferably, it is contemplated that, in the connected state, the plug axis and the connection axis are oriented parallel to each other or coaxially. In a parallel orientation of the plug axis relative to the connection axis, the connecting plug and the connection socket can be connected and separated in a simple linear movement. Preferably, the plug axis and the connection axis are oriented coaxial to each other and thereby form a common axis in the connected state.

Furthermore, it is contemplated that, in the connected state, the connection socket and the connecting plug are positively and non-positively connected, particularly clamped to each other in a direction parallel to the connection axis. In the connected state, the connection socket and the connecting plug of the connector are connected to each other without a clearance. This is achieved by an at least partial non-positive connection. With such a clearance-free connection, a reliable connection between the components of the connector is obtained which is long-term stable even in case of dynamic loads.

The object of the invention is also solved by a secured double plate comprising a base plate and a cover plate which are oriented parallel to each other and, at least in sections, abut on each other, the base plate and the cover plate being connected to each other by at least one connector according to one of the embodiments described above, and at least one support,

the connection socket being introduced into the base plate, and the connecting plug being connected to and, at least in sections, projecting beyond the cover plate,

and the base plate being connected to the support disposed on the side of the base plate facing away from the cover plate by the connection socket, the pressure surface abutting on a surface of the base plate facing the cover plate, and the securing element connecting, particularly non-positively connecting the connection socket to the support.

A secured double plate according to the invention comprises the components base plate, cover plate, and support. Here, the support preferably belongs to a frame construction which is provided to carry and position at least one plate, particularly a plate having a functional surface. The double plate is a combination of two plates among which, preferably, the base plate has a supporting, load-bearing function, and the cover plate provides for a functional surface facing away from the support. For example, a secured double plate according to the invention may be used for providing a formwork panel in the building sector. However, the secured double plate according to the invention is not limited to this application.

In the secured double plate according to the invention, the base plate and the cover plate are, at least in sections, placed on each other. It is possible that the base plate and the cover plate abut on each other over the entire surface area. The base plate is connected to the cover plate by at least one connector according to one of the embodiments described above. The support is positioned on the side of the base plate disposed opposite of the cover plate. Preferably, the support only abuts on a subsection of the surface the base plate. For example, the contact surface between the base plate and the support may be 2 to 25% of the surface of the base plate. The connection socket of the connector is, at least in sections, incorporated in the base plate. The connecting plug of the connector is disposed on or in the cover plate and projects, at least in sections, beyond the surface of the cover plate oriented in the direction of the base plate. In the mounted state, at least part of the bending portion of the connecting plug can be introduced into the receptacle of the connection socket, and the connector can be transferred into the connected state in this way. In the state in which the cover plate abuts on the base plate the connector is in the connected state and fixes the base plate relative to the cover plate in a direction parallel to the connection axis and to the plug axis. In addition, the connection socket is connected to the support by its securing element. The cover plate is secured to the support by or with the aid of the connection socket. In this non-positive connection, the flow of forces proceeds from the base plate through the pressure surface into the connection socket and from the connection socket through the securing element into the support. Here, the pressure surface extensively abuts on a surface of the base plate oriented in the direction of the cover plate. In this attachment, the pressure surface has an effect similar to a washer in a normal screw connection and expands the force introduction surface for the non-positive connection between the base plate and the support. In the secured double plate according to the invention, the cover plate can be detached from the base plate in an extremely easy manner. To this end, only the connected state of the connector has to be released which may take place by applying a force parallel to the connection axis or to the plug axis in a direction away from the support. In the secured double plate according to the invention, the removal of the cover plate is therefore possible in an extremely easy fashion. Likewise, the installation of the same or of another cover plate on the base plate can also be readily performed by moving the cover plate towards the base plate by applying a pressure force acting towards the support. When the cover plate is removed or replaced, the connection between the base plate and the support may remain intact. This is advantageous in that, in case of wear of the cover plate, it can be easily and quickly exchanged while the base plate and the support will still remain connected to each other. Owing to the two plates arranged parallel to each other, these may be implemented so that the base plate has the supporting properties, and the cover plate is configured so that it is lightweight and has a small thickness. In this case, the exchange of the cover plate is considerably more resource conserving than in case of a solution in which only a single plate is used to provide for both the supporting properties and the required surface properties.

In one embodiment of the secured double plate, it is contemplated that the cover plate has a functional surface facing away from the base plate, and that the cover plate is separable from the base plate by disengaging the connector, the connection between the cover plate and the base plate being detachable by applying a force which acts parallel to the connection axis and is directed away from the base plate. In this embodiment, a functional surface is applied to the surface of the cover plate facing away from the base plate and the support. In the example in which the secured double plate is used for providing a formwork panel, the functional surface of the cover plate may be formed by a concrete-repellent and water-repellent coating. As described above, the cover plate is separable from the base plate in a simple manner by releasing the connector. In case of wear of the functional surface on the cover plate, it can therefore be easily exchanged. A secured double plate therefore facilitates the exchange or replacement of a functional surface on a plate which is secured to an underlying frame construction.

In another embodiment, it is contemplated that the cover plate is formed by a formwork facing, the base plate by a reinforcing plate, and the support by a formwork frame, a plurality of connectors disposed at a distance to each other detachably connecting the cover plate, the base plate, and the support to each other in the connected state. In this specific embodiment, the secured double plate is implemented as part of a formwork for the building sector. Here, the support is formed by a formwork frame which preferably constitutes a mesh structure of steel profiles. The base plate is a reinforcing plate connected to the formwork frame which is provided to support and to dissipate forces from the actual formwork facing. The base plate may be formed by a metal plate, or likewise by a plastic plate, or by an untreated wooden plate be here. The cover plate is formed by a formwork facing having a concrete-repellent functional surface on its side facing away from the reinforcing plate. The cover plate as the formwork facing has a thin configuration and has no supporting properties. In case of wear of the functional surface, the cover plate can be quickly replaced in an easy manner as described above, the remaining structure of the formwork not having to be changed. However, if required, a replacement of the base plate or the reinforcing plate detachably connected to the support via the connection socket is also possible. In this embodiment, preferably, a plurality of connectors is disposed between the base plate and the cover plate, said connectors preferably being arranged in their peripheral area.

The object of the invention is also solved by using a connector according to one of the embodiments described above for connecting a base plate to a cover plate, the connection socket being introduced into the base plate, and the connecting plug being connected to and, at least in sections, projecting beyond the cover plate, and the pressure surface abutting on a surface of the base plate facing the cover plate, and the securing element connecting, particularly non-positively connecting the connection socket to a support. With the inventive use of a connector according to one of the embodiments described above for connecting a cover plate to a base plate and to a support, the replacement of a functional surface applied to the cover plate is facilitated as compared to prior art. Here, the support is preferably part of a frame construction carrying the two plates.

The object of the invention is finally solved by a method for securing at least two plates on a support using at least one connector according to one of the embodiments described above comprising the steps of:
A) securing a base plate on a support, the pressure surface of the connection socket being placed on a surface of the base plate, and the securing element of the connection socket being connected to the support, the base plate being non-positively and/or positively connected to the support by the connection socket in the end of process step A),
B) securing a cover plate on the combination of the base plate and the support of process step A), a connecting plug being secured on a surface of the cover plate, and the connecting plug being inserted into the connection socket connected to the base plate, and the connector thus being transferred into the connected state.

The method according to the invention serves to secure two plates on a support. Preferably, the method is carried out in the indicated order of the process steps A) and B). For separating the two plates from the support, the method according to the invention can be carried out in the reverse order.

In a first process step, a base plate is secured on a support. Here, the support is preferably part of a frame construction carrying the two plates. For securing the base plate to the support, the connection socket of the connector is used. Its pressure surface is placed on a surface of the base plate facing away from the support. Then, the securing element is connected to the support. This connection results in the base plate being clamped to the support. Here, the flow of forces for this interlock is guided through the connection socket. In the end of process step A), the base plate is non-positively and preferably also positively connected to the support.

In a second process step B), the cover plate is secured on the combination of the base plate and the support already established by the connector. To this end, a connecting plug secured to the surface of the cover plate facing the base plate is inserted into the connection socket introduced into the base plate, and the connected state is established. This connected state can be established in an easy manner by applying a pressure force to the cover plate which proceeds parallel to the connection axis and to the plug axis in the direction of the support.

In the method according to the invention, therefore, first the base plate is secured on the support, and then the cover plate is secured on the base plate. The method according to the invention is easy to perform. The method may optionally also be supplemented by additional process steps. For example, the cover plate may be separated from the base plate and replaced in another process step. However, this optional additional process step is preferably only performed considerably later, particularly when the cover plate is worn after extended use and should be exchanged or replaced.

The features, effects and advantages described in connection with the connection socket, the connector, and the secured double plate can also be analogously applied to the use and the method and are therefore deemed included in the disclosure. The same applies in the reverse direction: features, effects and advantages described in connection with the method or the use are also applicable to the connection socket, the connector, and the secured double plate and are deemed included in the disclosure.

### BRIEF DESCRIPTION OF THE DRAWINGS

In the Figures, embodiments of the invention are schematically illustrated. Here,

FIG. 1 shows a perspective view of a first embodiment of a connection socket according to the invention,

FIG. 2 shows a cross-sectional view of a first embodiment of a connection socket according to the invention,

FIG. 3 shows a perspective view of a first embodiment of a connecting plug,

FIG. 4 shows a cross-sectional view of a first embodiment of a connecting plug,

FIG. 5 shows a secured double plate in an overview representation in a plurality of perspectives,

FIG. 6 shows a cross-sectional view of a first embodiment of a connector according to the invention,

FIG. 7 shows a cross-sectional view of a second embodiment of a connection socket according to the invention,

FIG. 8 shows a perspective view of a third embodiment of a connection socket according to the invention,

FIG. 9 shows a perspective view of a second embodiment of a connecting plug,

FIG. 10 shows a cross-sectional view of a second embodiment of a connector according to the invention,

FIG. 11 shows a perspective view of a fourth embodiment of a connection socket according to the invention,

FIG. 12 shows a cross-sectional view of a fourth embodiment of a connection socket according to the invention,

FIG. 13 shows three cross-sectional views of a support with a mounted connection socket, in

FIG. 13a with a fifth embodiment of a connection socket,

FIG. 13b with a sixth embodiment of a connection socket and

FIG. 13c with a seventh embodiment of a connection socket.

### DETAILED DESCRIPTION

In the Figures, identical elements are designated by the same reference numerals. Generally, the described properties of an element described with reference to one Figure also apply to the other Figures. Directional information such as top, bottom, right, or left relate to the described Figure and should be applied to the other Figures by analogy.

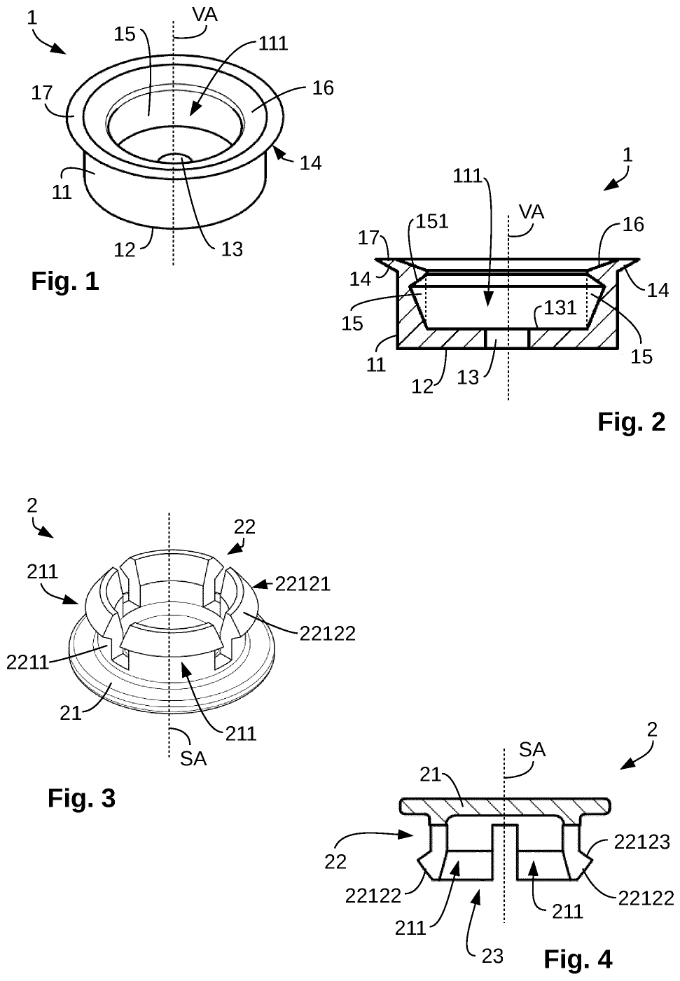

FIG. 1 shows a perspective view of a first embodiment of a connection socket 1 according to the invention. A connection axis VA which is an imaginary axis in the direction of which the connection socket 1 can be connected to a connecting plug 2 as illustrated, for example, in FIG. 3 is vertically drawn in the illustration. The connection axis VA therefore corresponds to a connecting direction in which the connection socket 1 and a connecting plug 2 can be connected to a connector 100 as illustrated, for example, in FIG. 6. The connection and separation of this connector 100 is preferably carried out in the direction of the connection axis VA. The connection axis VA further serves as an imaginary, auxiliary geometry for describing the configuration of the connection socket 1.

The connection socket 1 comprises a casing 11 which extends along the connection axis VA and completely encloses the connection axis VA in the illustrated embodiment. However, it is also possible that the casing 11 only partly encloses the connection axis VA. In this embodiment, the outer surface of the casing 11 facing away from the connection axis VA has the shape of a circular cylinder. The outer surface of the casing 11 may also have another form and may, for example, have the shape of a cube. The wall thickness of the casing 11 varies along the connection axis VA which can be seen in FIG. 2. In the interior of the casing 11, a receptacle 111 is disposed which is provided for accommodating a subsection of a connecting plug 2. The receptacle 111 is delimited by the casing 11. In the illustrated embodiment, the receptacle 111 has the shape of two truncated cones connected to each other which can be seen in detail in the cross-sectional view in FIG. 2. The connection socket 1 comprises a base region 12 which is visible through the receptacle 111 in the perspective view in FIG. 1. The base region 12 is connected to the casing 11 and extends perpendicular to the connection axis VA. The base region 12 delimits the receptacle 111 and the entire connection socket 1 in the direction of the connection axis VA on the lower side. In the illustrated embodiment, the base region 12 is implemented as a planar circular disc the centre of which is located in the point of intersection with the connection axis VA. Here, the base region 12 delimits the receptacle 111 together with the casing 11. The connection socket 1 further comprises a securing element 13 which is implemented as a mounting aperture which extends through the base region 12 and is oriented coaxial to the connection axis VA in the illustrated embodiment. Into this mounting aperture, a mounting component, for example, a screw can be introduced for securing the connection socket. Such a securing element implemented as a mounting aperture may alternatively also be disposed in and extend through the casing 11. It is further possible to provide a plurality of securing elements 13 which are disposed in various positions on or in the connection socket 1. The connection socket 1 further comprises a pressure surface 14 which is disposed on the lower side of a collar 17 connected to the casing 11 here. The collar 17 is disposed in the end of the casing 11 facing away from the base region 12 in the direction of the connection axis VA. The collar 17 extends from the outer surface of the casing 11 in the radial direction away from the connection axis VA. The pressure surface 14 is formed by a circumferential, conically shaped surface on the lower side of the collar 17. The pressure surface 14 is provided for retaining and fixing a structural element, particularly a plate into which the casing 11 of the connection socket 1 is inserted. Details on this fixation are described in connection with FIG. 6. In an alternative embodiment, the collar 17 may also omitted, and a pressure surface 14 can be disposed on the planar side of the base region 12 facing downwards.

The connection socket 1 further comprises an undercut 15 which forms a cavity in the interior of the casing 11. In the illustrated embodiment, this undercut 15 is part of the recess 111. The undercut 15 is disposed between the base region 12 and the collar 17 in an inner circumferential surface of the casing 11. The undercut 15 is delimited by elements or portions of the connection socket 1 projecting in the radial direction to the connection axis VA on two opposite sides in the direction of the connection axis VA. In the interior of the casing 11, the undercut 15 is implemented so that it is open towards the inside in the radial direction to the connection axis VA. In the state connected to a connecting plug 2, the undercut 15 serves to accommodate a latching element 2212. In the connected state, the undercut 15 and the latching element 2212 will then establish a positive connection. This can be seen, for example, in FIG. 6. Moreover, the connection socket 1 comprises an insertion surface 16, which is disposed on the casing 11 and/or on the collar 17. In the illustrated embodiment, this insertion surface 16 has a conical design and extends in the radial direction to the connection axis VA, the insertion surface 16 also being inclined relative to the connection axis VA. In the illustrated embodiment, the insertion surface 16 is circumferentially disposed around the connection axis VA. The insertion surface 16 facilitates the insertion of a connecting plug 2. In alternative embodiments, the insertion surface 16 may also only be disposed around the connection axis in the circumferential direction in sections. In addition, it is possible that the insertion surface 16 has a shape other than the illustrated conical shape. For example, it is possible to implement the insertion surface so that it is curved in one or more directions. It is further possible to provide a plurality of insertion surfaces 16 which are spaced apart from each other and which have planar surfaces, respectively. In the illustrated embodiment, the entire connection socket 1 is formed so that it is rotationally symmetrical about the connection axis VA. In this way, such a connection socket 1 can be connected to a connecting plug 2 in the same way in any rotational position. This facilitates the installation of the connection socket 1 and the connection to a connecting plug 2. Alternatively, the connection socket 1 may also have another shape and exhibit, for example, a rectangular or square outer shape in a plan view from the direction of the connection axis VA. In such an embodiment, an associated connecting plug 2 will then have to be correctly rotated and positioned relative to the geometry of the connection socket 1 prior to being connected. Such a non-rotationally symmetrical shape is appropriate when a connection is to be possible only in a specific alignment of the connection axis 1 and the connecting plug 2.

FIG. 2 shows a cross-sectional view of a first embodiment of a connection socket 1 according to the invention. In FIG. 2, the first embodiment of a connection socket 1 of FIG. 1 is illustrated as cut in a sectional plane in which the connection axis VA extends. The sectional plane therefore halves the connection socket 1. The base region 12 has a boundary surface facing downwards which is oriented perpendicular to the connection axis VA. The base region 12 completes the casing 11 on the side facing downwards. In the base region 12, the securing element 13 in the form of a mounting aperture is centrally disposed. On the side of the base region 12 facing upwards, a plane surface adjoins adjacent to the securing element 13. This plane surface can be used as a force introduction surface 131 on which, for example, a screw head of a screw introduced into the securing element 13 may abut. With the force introduction surface 131, a good transfer of forces and therefore a reliable attachment of the connection socket 1 to other elements is ensured. In the cross-sectional representation, the pressure surface 14 disposed on the collar 17 can be clearly seen. The pressure surface 14 extends in the radial direction from the outer surface of the casing 11 away from the connection axis VA and is inclined with respect to the connection axis VA here. The diameter of the end of the collar 17 facing upwards is larger than the outer diameter of the casing 11. In the illustrated embodiment, the insertion surface 16 is disposed, in sections, on the collar 17, and, in sections, on the casing 11. The insertion surface 16 is disposed adjacent to the undercut 15, a transition area having a rounded design being disposed between the insertion surface 16 and the undercut 15.

In the interior of the casing 11, the receptacle 111 is disposed. The receptacle 111 is delimited by the casing 11 in the circumferential direction about the connection axis VA. On the face side facing downwards, the receptacle 111 is delimited by the base region 12. On the face side facing upwards, the receptacle 111 is open, the insertion surface 16 adjoining the open side of the receptacle 111. The undercut 15 is disposed on the inner side of the casing 11 oriented towards the connection axis VA and forms a part of the receptacle 111. For better visibility, a vertically extending, dashed line is indicated, starting from the base region 12, to the insertion surface 16 which is an imaginary delimitation of the undercut 15 in the direction of the connection axis VA.

In the illustrated cross-sectional view, the undercut 15 therefore has a triangular cross section which is oriented around the connection axis VA and therefore defines a ring-shaped undercut 15. The undercut 15 is delimited by elements projecting in the radial direction to the connection axis VA and adjoining the undercut 15 on two opposite sides in the direction of the connection axis. Above the undercut 15, a protrusion disposed on the end of the insertion surface 16 facing radially towards the inside projects in the radial direction to the connection axis VA as an adjacent element. Below the undercut 15, the transition area between the casing 11 and the base region 12 projects beyond the undercut 15 towards the inside to the connection axis VA in the radial direction. The undercut 15 therefore forms a cavity in the interior of the casing 11 which can only be accessed in the radial direction to the connection axis VA. The undercut 15 has a support surface 151 which is disposed on the side facing away from the base region 12. The support surface 151 forms a surface which a connecting plug 2 connected to the connection socket 1 establishes a positive connection with. The support surface 151 is oriented at an acute angle to a plane extending perpendicular to the connection axis VA. In the illustrated embodiment, the support surface 151 has a conical shape and encloses the entire connection axis VA. The inclination of the support surface 151 is opposite to the inclination of the insertion surface 16. The radial distance of the edge of the insertion surface 16 facing away from the base region 12 to the connection axis VA is larger than the radial distance of the edge of the insertion surface 16 facing the base region. Therefore, the insertion surface 16, starting from its edge facing away from the bottom surface 12, is inclined so that it approaches the connection axis VA towards the edge facing bottom surface 12. For the support surface 151, exactly the opposite holds true. The support surface, starting from its edge facing away from the base region 12, is inclined away from the connection axis VA towards its edge facing the base region 12. The insertion surface 16 and the support surface 151 are disposed adjacent to each other and oriented at an acute angle with respect to each other. In the illustrated embodiment, both the insertion surface 16 and the support surface 151 have a conical design, the two surfaces being oriented relative to each other so that the side of the cone having the smaller diameter is disposed adjacent to the other surface. The undercut 15 has another conically shaped boundary surface which connects the support surface 151 to the base region 12 on its side facing the base region 12. However, the shape this other boundary surface may also have different designs since it only serves to provide for sufficient space for accommodating portions or components of a connecting plug 2 inserted into the connection socket 1. In the illustrated embodiment, the receptacle 111 including the undercut 15 has the shape of a double truncated cone, the support surface 151 forming an upper truncated cone, and the other boundary surface of the undercut 15 forming a second, lower truncated cone. The broader sides of both truncated cones are oriented towards each other. Owing to the described combination of the shapes of the insertion surface 16, the undercut 15, and the support surface 151, a connecting plug 2 can be introduced into the connection socket 1 along the connection axis VA with a low mounting force, and a large retaining force along the connection axis VA is provided for in the connected to state. The design of the illustrated embodiment is easy to handle, robust, and can be inexpensively produced as a plastic part.

FIG. 3 shows a perspective view of a first embodiment of a connecting plug 2. The illustrated connecting plug 2 is the counterpart to the connection socket 1 according to the first embodiment of FIGS. 1 and 2. This connecting plug 2, together with the connection socket 1, may form a connector 100 illustrated in the connected state in a cross-sectional view in FIG. 6. The connecting plug 2 has a base 21 shown below in the illustration which carries the other elements of the connecting plug 2. The base 21 is implemented as a circular disc here. However, the base 21 may also have another shape. The connecting plug 2 is connected to another element, for example, a plate through the base 21. The base 21 may be individually adapted so that it is optimised for a connection to another element. In the illustrated embodiment, the base 21 implemented in a disc shape is optimised for the connection to an adapter 6 which is illustrated in FIG. 6. An imaginary plug axis SA extends perpendicular to the base 21. The plug axis SA defines the direction in which the connecting plug 2 can be connected to and separated from a connection socket 1. When the connection socket 1 is joined with the connecting plug 2 the plug axis SA and the connection axis VA are coaxially aligned with respect to each other. The imaginary plug axis SA also serves the facilitated description of the components of the connecting plug 2. Above the base 21, the connecting plug 2 has a bending portion 22 which comprises four elastically deformable bending arms 221 here. These bending arms 221 will elastically deform when a connection to a connection socket 1 is established and separated. Inside the four bending arms 221, an interior bending space 23 is disposed through which the plug axis SA extends. The interior bending space 23 is open on its side facing away from the base 21. The interior bending space 23 provides for a space which the deformed bending arms 221 can enter when the bending arms 221 are deformed. It is also possible to provide more or less than the illustrated four bending arms 221. Each bending arm 221 comprises a bending element 2211 connected to the base 21. This bending element 2211 is elastically deformable in a radial direction to the plug axis SA. During an elastic deformation in this direction, the bending element 2211 builds up a spring force which can be used for fixing the connecting plug 2 in a connection socket 1. On the side of each bending element 2211 facing away from the base 21, a latching element 2212 is disposed which is provided for establishing a positive connection to the undercut 15 of a connection socket 1 during a connection to the connection socket 1. On the latching element 2212, a protrusion 22121 is disposed which forms the portion of a bending arm 221 projecting the furthest from the plug axis SA in the radial direction. Here, the protrusion 22121 protrudes beyond the bending element 2211. On the latching element 2212 and/or the protrusion 22121, two functional surfaces are provided which are required during the connection to a connection socket 1. On the side of the latching element 2212 facing away from the base 21, a mating surface 22122 is disposed which is formed like a subsection of a cone here. The mating surface 22122 extends in the radial direction to the plug axis SA and is inclined towards the plug axis SA. The mating surface 22122 is brought in contact with the insertion surface 16 for establishing a connection to a connection socket 1. As a result of the interaction of the insertion surface 16 and the mating surface 22122, the bending arm 221 is elastically deformed so that it can be inserted into the receptacle 111 of the connection axis 1. The mating surface 22122 may also have a curved or rounded design. Adjacent to the mating surface 22122, a fixation surface 22123 is disposed on the latching element 2212 as a second functional surface. The fixation surface 22123 is disposed on the side of the latching element 2212 facing away from the mating surface 22122 in the direction of the plug axis SA. The fixation surface 22123 abuts on the support surface 151 in the state of the connecting plug 2 in which it is connected to a connection socket 1. In the illustrated embodiment, the fixation surface 22123 is implemented as a subsection of a cone the inclination of which is complementary in shape to the support surface 151 of the connection socket 1. The fixation surface 22123 projects beyond the bending element 2211 towards the outside in the radial direction to the plug axis SA. In the illustrated embodiment, the bending portion 224 comprises bending arms 221 disposed regularly around the plug axis SA. The number of the bending arms 221 may also be different in other embodiments; for example, two, three, or six bending arms 221 may be provided. The bending arms 221 are disposed at the same distance to the plug axis SA, and the plug axis SA forms the central axis of the bending portion 22.

FIG. 4 shows a cross-sectional view of a first embodiment of a connecting plug 1. In FIG. 4, the connecting plug 2 of FIG. 3 is illustrated in a cross section, the plug axis SA being located in the sectional plane. The sectional plane extends between the bending arms 221 so that these are not illustrated in the cross section. The individual subsections of the connecting plug 2 are described in connection with FIG. 3, this description also applies to FIG. 4. In the cross-sectional view of

FIG. 4, two of the bending arms 221 can be seen. These bending arms 221 are disposed so that they are symmetrical to the plug axis SA. Between the base 21 and the latching element 2212, the bending element 2211 of each bending arm 221 has a constant thickness in the direction of the plug axis SA. In FIG. 4, the connecting plug 2 is illustrated in an orientation in which it can be inserted into and connected to the connection socket 1 illustrated in FIG. 2. In the beginning of a connection of the connecting plug 2 to the connection socket 1, first, the plug axis SA and the connection axis VA are oriented so that they are coaxial relative to each other. Then, the mating surface 22122 is brought in contact with the insertion surface 16. Then, a force pressing the connecting plug 2 and the connection axis 1 together is applied parallel to the plug axis SA and to the connection axis VA. By applying this force, the bending arms 221 are bent towards the inside in the interior bending space 23 by the interaction of the mating surface 22122 and the insertion surface 16. In this state, the bending portion 22 fits through the opening in the interior of the insertion surface 16, and the latching elements 2212 can enter the receptacle 111 and the undercut 15. There, the bending arms 221 elastically spring back into their original shape so that the fixation surfaces 22123 get into contact with the support surface 151. In this connected state, the connecting plug 2 and the connection axis 1 are then non-positively and positively fixed to each other. This connected state is illustrated in FIG. 6.

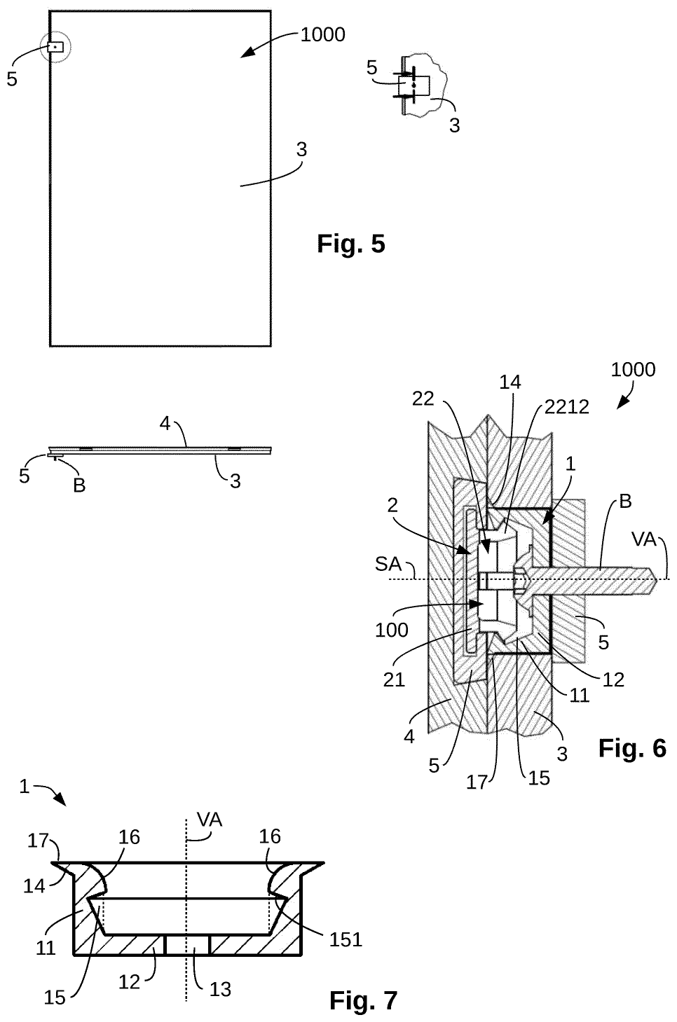

FIG. 5 shows a secured double plate 1000 in an overview representation in a plurality of perspectives. The illustrations in FIG. 5 show an application in which a connector 100 can be used. A double plate 1000 comprising a base plate 3 and a cover plate 4 which are connected to each other can be seen. The base plate 3, together with the cover plate 4, is secured to a support 5. In FIG. 5, the double plate 1000 is illustrated in a simplified manner. On the top left of the plan view, the double plate 1000 can be seen from below. In the foreground, there is the base plate 3 which carries the cover plate 4 which is disposed in the background and is therefore not illustrated. In the top left corner, a support 5 is illustrated by way of example. The double plate 1000 is connected to this support 5. The support 5 is implemented as a plate which is made of a solid material, for example, of construction steel. For securely supporting the double plate 1000, preferably, a plurality of supports 5 according to the illustrated embodiment which may be disposed in various positions below the cover plate 3 are used for mounting. The support 5 may also have a larger configuration and extend, for example, along the entire length of an edge of the double plate 1000. The support 5 is part of a frame construction which carries and positions one or a plurality of double-plates 1000. On the bottom left of FIG. 5, a side view of the secured double plate 1000 can be seen. In this side view, the cover plate 4 illustrated on the top can be seen. The cover plate 4 extensively abuts on the base plate 3. Below the two plates, the support 5 can be seen on the left. A mounting component B which is guided through a securing element 13 implemented as a mounting aperture and retains a connection socket 1 projects downwards beyond the support 5. Details on this connection can be seen in the cross-sectional view in FIG. 6. In the illustrated embodiment, the base plate 3 and the cover plate 4 have substantially the same size in a plan view as illustrated on the top left. On the top right in FIG. 5, the detail marked with a circle in the plan view on the top left which comprises the support 5 is illustrated on an enlarged scale. On the top right in this illustration, the sectional plane for the view in FIG. 6 showing the cut, secured double plate 1000 including a connector 100 is defined by the two arrows.

FIG. 6 shows a cross-sectional view of a first embodiment of a connector 100 according to the invention. The illustration shows a cross section of the secured double plate 1000 in a sectional plane shown on the top right in FIG. 5. In this view as well, the connector 100 can be seen which connects the cover plate 4 and the base plate 3 and, at the same time, fixes the base plate 3 on the support 5. The connector 100 comprises a connection socket 1 according to the embodiment illustrated in FIGS. 1 and 2, as well as a connecting plug 1 according to the embodiment illustrated in FIGS. 3 and 4. The connection socket 1 is introduced into a cylindrical opening in the base plate 3. Here, the diameter of this cylindrical opening corresponds to the outer diameter of the casing 11 or is implemented so that it is slightly larger. The outer diameter of the collar 17 is larger than the inner diameter of the opening in the base plate 3. In this way, the collar 17 abuts on the edge of the cylindrical opening in the base plate 3 on the side facing leftwards in the illustration. In this way, a positive connection is given between the connection socket 1 and the base plate 3 in the direction of the connection axis VA. Owing to the projecting collar 17, the connection socket 1 cannot be moved further to the right through the cylindrical opening in the base plate 3. The securing element 13 of the connection socket 1 is implemented as a mounting aperture through which the mounting component B is guided. The mounting component B is formed by a screw having a flat head. The flat head of the mounting component B extensively abuts on the force introduction surface 131 having a planar design. The mounting component B has a male thread which is screwed into a female thread in the support 5. The mounting component B pulls the connecting sleeve 1 towards the right when it is screwed into the female thread parallel to the connection axis. As a result of the positive connection between the collar 17 and the surface of the base plate 3 facing towards the left, the mounting component B, together with the base plate 3, clamps the connection socket 1 to the support 5. Owing to the large contact surface between the pressure surface 14 disposed on the right side of the collar 17 and the surface of the base plate 3 facing away from the support 5, the base plate 3 is stably and symmetrically clamped to the support 5. In this interlock or fixation, the pressure surface 14 has an effect similar to a washer so that the surface pressure between the connecting sleeve 1 and the base plate 3 is kept low. In this way, neither the connecting sleeve 1 nor the base plate will be damaged in this connection, and, at the same time, a long-term, stable connection is ensured. For obtaining a statically specific restraint, there is a distance between the lower side of the base region 12 of the connecting sleeve 1 facing towards the right and the support 5 so that the base region 12 does not abut on the support 5. In alternative embodiments, however, the pressure surface 14 may also be disposed on the base region 12. Such an embodiment can be seen, for example, in FIG. 10. The connecting sleeve 1 fulfils the function of a securing element by means of which the base plate 3 is clamped to the support 5. This connection is releasable in an easy manner by removing the connecting component B so that the base plate 3 can be exchanged when required. The connection socket 1 has another function, namely, it forms one half of a disengageable connector 100 by means of which the cover plate 4 is secured to the base plate 3. FIG. 6 shows the connected state of the connector 100 in which a connecting plug 2 is introduced into and fixedly but detachably connected to the connecting socket 1. The connecting plug 2 is connected to the cover plate 4 via the adapter 6. Here, the connecting plug 2, in sections, projects beyond the surface of the cover plate 4 facing towards the right in the illustration. In the illustrated embodiment, the bending portion 22 of the connecting plug 2 projects beyond the cover plate 4. The adapter 6 positively connects the cover plate 4 to the connecting plug 2. To this end, the base 21 is inserted into a recess having two undercuts in the adapter 6. The adapter 6 renders an easy replacement of the connecting plug 2 possible. Such a replacement may be required, for example, when the connecting plug 2 is damaged or worn. An introduction of the connecting plug 2 into the adapter 6 may be carried out, for example, from the edge of the cover plate 4. The adapter 6 may be implemented and disposed so that the recess having the two undercuts is accessible from the edge of the cover plate 4. As a result of the positive connection between the base 21 and the undercut in the recess in the adapter 6, a positive connection is established between the two components in the direction of the plug axis SA. The adapter 6, in turn, is positively introduced into a recess in the cover plate 4. In the illustrated cross-sectional view, the recess in the cover plate 4 has the shape of a dovetail into which the adapter 6 can be inserted in press fit from the edge of the cover plate 4. Such a recess in the cover plate 4 may be produced in a simple manner, for example, by milling. Of course, it is also possible to connect the connecting plug 2 to the cover plate 4 in another way, for example, by means of screws or also an adhesive. In the illustrated connected state, the bending portion 22 of the connecting plug 2, in sections, is introduced into the recess 111 of the connection socket 1. The latching elements 2212 are introduced into the undercut 15 so that a positive connection is established in the direction of the plug axis SA and the connection axis VA. Here, the fixation surfaces 22123 flatly abut on the support surfaces 151. The latching elements 2212 are pushed radially towards the outside away from the connection axis VA by an elastic return force produced in the bending elements 2211. Owing to this elastic return force, therefore, also a non-positive connection is established between the fixation surfaces 22123 and the support surface 151. In this way, the connection socket 1 and the connecting plug 2 are always connected to each other without a clearance. In this way, a secure fixation of the cover plate 4 on the base plate 3 is ensured. In the connected state, each fixation surface 22123 is oriented parallel to a support surface 151. Both surfaces are inclined with respect to the connection axis VA and to the plug axis SA. Here, inclined means that these surfaces are oriented at an angle of 1° to 89° to the connection axis VA and to the plug axis SA. When a force directed away from the base plate 3 is applied to the cover plate 4 parallel to the plug axis SA this force is translated into a force acting radially towards the inside in the direction of the plug axis SA on each bending arm 221 by the two inclined surfaces abutting on each other, the fixation surface 22123 and the support surface 151. In this way, the bending arms 221 are bent towards the inside in the direction of plug axis SA which finally results in that the latching elements 2212 are no longer positioned in the undercut 15, and that the positive connection between connecting plug 2 and connection axis 1 is released. In this state, the connecting plug 2 can then be pulled out of the connection socket 1. This separation is reversible; this means that none of the involved elements is damaged in the process. The connection can therefore be repeatedly established and separated. For connecting the connecting plug 2 to the connection axis 1, the mating surfaces 22122 of the bending arms 221 are placed on the insertion surface 16, and then a force acting from the cover plate 4 in the direction of the base plate 3 is applied parallel to the plug axis SA. Since these surfaces are also implemented so that they are inclined the bending arms 221 are bent towards the inside so that, finally, the latching elements 2212 again enter the undercut 15. The connection of the cover plate 4 to the base plate 3 can therefore be established and separated again in an easy manner by applying forces oriented perpendicular to the cover plate 4. For this purpose, no tool is required which renders separating and connecting extremely easy. Should wear occur after repeated separating and connecting the connecting plug 2 can be exchanged in an easy manner as described above. An exchange of the connection socket 1 is also possible in an easy manner due to the reversible connection via the mounting component B. Preferably, the cover plate 4 has a functional surface on its side facing away from the base plate 3. This functional surface may be formed, for example, by a coating having water-repellent properties. Such a functional surface is required, for example, in the formwork facing of a formwork panel. An advantage of the secured double plate 1000 is that the cover plate 4 having a functional surface can be exchanged in an easy manner independent of the base plate 3. In the event of wear of the functional surface, the cover plate 4 can be detached from the cover plate 3 by separating the connector 100 to which end only a force acting perpendicular to the surface of the cover plate 4 has to be applied. In the process, the cover plate 3 remains fixedly connected to the support 5 by the connection socket 1. In this way, the supporting structure comprised of the support 5 and the base plate 3 remains unchanged and is not affected by a replacement of the cover plate 4. This renders a fast and, at the same time, save exchange of a functional surface possible. Here, the cover plate 4 may have a relatively thin design and does not have to exhibit any load-bearing properties for accommodating forces and momentums. In the event of an exchange of the functional surface by an exchange of the cover plate 4, therefore, considerably lower costs will arise, and considerably less waste is produced than in case of the arrangement of a functional surface on a single supporting plate to which a support 5 is connected. Preferably, in a secured double plate 1000, a plurality of spaced-apart connectors 100 are used for connecting the cover plate 4 to the base plate 3 and the support 5.

FIG. 7 shows a cross-sectional view of a second embodiment of a connection socket 1 according to the invention. The illustrated second embodiment is similar to the first embodiment of FIGS. 1 and 2. Unless illustrated otherwise, the description with reference FIGS. 1 and 2 is made reference to with regard to the individual portions and components of the connecting sleeve 1 of FIG. 7. The second embodiment illustrated in FIG. 7 differs from the first embodiment in the shape of the insertion surface 16. This insertion surface 16 according to the second embodiment has a curved design whereas the insertion surface 16 according to the first embodiment has conical design. In the cross-sectional view in FIG. 7, the insertion surface 16 therefore has a curved cross section composed of portions having different radii of curvature. However, these portions having different radii of curvature uniformly merge into each other. This shape of the insertion surface is particularly favourable to keep the force required for inserting a connecting plug 2 into the connection socket 1 low. It has been found that the connecting force required for this connection can be effectively reduced by either the insertion surface 16 or its counterpart on the connecting plug, namely, the mating surface 22121 having a curved design. The second embodiment of the connection socket 1 is therefore suitable for a connection to a connecting plug having a mating surface 22121 which has a conical design and is therefore not curved such as, for example, according to the embodiment of FIGS. 3 and 4. Alternatively, the insertion surface 16 may also have a design which is not curved, for example, conical as illustrated in FIGS. 1 and 2; and, instead, the mating surface 22121 may have a bent or curved shape. The shape of the support surface 151 according to the embodiment of FIG. 7 has a conical design like in the embodiments of FIGS. 1 and 2. Such an embodiment is particularly favourable for rendering a high retaining force possible in the connected state of the connection socket 1 and the connecting plug 2.

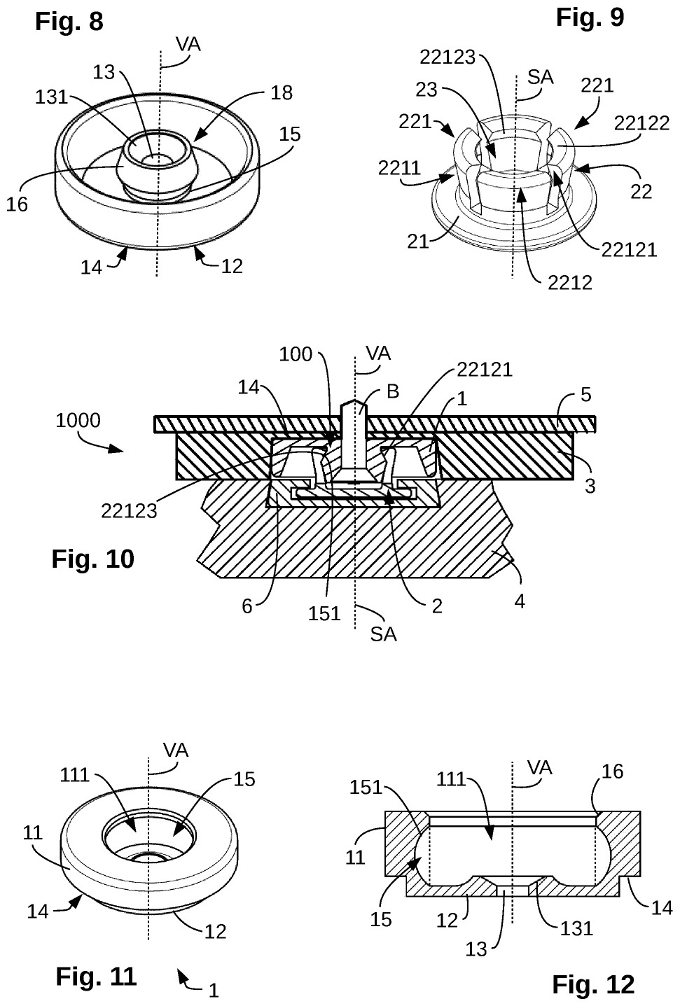

FIG. 8 shows a perspective view of a third embodiment a connection socket 2 according to the invention. The illustrated third embodiment of a connection socket 1 differs from the first and the second embodiment particularly in the arrangement of the pressure surface 14 on the base region 12 as well as in the arrangement of the undercut 15 in the interior of the receptacle 111. In the illustrated embodiment, the casing 11 has a cylindrical outer surface. The third embodiment has a connecting protrusion 18 which is disposed in the receptacle 111 and enclosed by the casing 11. The connecting protrusion 18, starting from the base region 12, extends in the direction of the connection axis VA. On the connecting protrusion 18, on its side facing away from the base region 12, the insertion surface 16 is disposed which has a conical design. In this embodiment, the securing element 13 is implemented as a mounting aperture which extends coaxial to the connection axis VA and extends through the connecting protrusion 18. Adjacent to the mounting aperture, a conically shaped force introduction surface 131 is disposed on the side of the connecting protrusion 18 facing away from the base region 12. The undercut 15 according to this embodiment is located between the base region 12 and the insertion surface 16 and extends in the circumferential direction around the connecting protrusion 18. The connecting protrusion 18 is implemented so that it is rotationally symmetrical around and disposed coaxial to the connection axis VA. The receptacle 111 is disposed between the connecting protrusion 18 and the casing 11 and ring-shaped in a plan view from the direction of the connection axis VA. The undercut 15 is open towards the receptacle 11. This side which is open in the radial direction to the connection axis VA is disposed on the side of the undercut 15 facing away from the connection axis VA in this embodiment. In the illustrated third embodiment, some functional areas of the connection socket 1 which are disposed adjacent to or adjoin the casing 11 in the first two embodiments are disposed on a connecting protrusion 18 disposed centrally in the recess 111. A connecting plug 2 matching the third embodiment of the connection socket 1 is illustrated in FIG. 9.

FIG. 9 shows a perspective view of a second embodiment of a connecting plug 2. The illustrated second embodiment of a connecting plug 2 is provided for the connection to a connection socket 1 according to the third embodiment illustrated in FIG. 8. A connector 100 including a connecting plug 2 according to the second embodiment is illustrated in the connected state in a cross-sectional view in FIG. 10. The connecting plug 2 according to the second embodiment is similar to the connecting plug 2 according to the first embodiment of FIGS. 3 and 4. Unless illustrated otherwise, the description of the individual components or elements of the connecting plug 2 with reference to FIGS. 3 and 4 also applies to FIG. 9. In the connecting plug 2 according to the second embodiment, likewise, four bending arms 221 are disposed around the plug axis SA. In contrast to the first embodiment, however, these bending arms 221 are bent radially towards the outside, away from the plug axis SA during a connection to a connection socket 1 in the second embodiment. In the second embodiment, the protrusion 22121 of the latching element 2212 of each bending arm 221 is oriented towards the inside in direction to the plug axis SA. The mating surface 22122 is also disposed on the side of the latching element 2212 facing the plug axis SA. The fundamental design and the function, particularly of the subsections of the bending arms 221, are identical to the first embodiment.

FIG. 10 shows a cross-sectional view of a second embodiment of a connector 100 according to the invention. In addition, this view shows a second embodiment of a secured double plate 1000. The second embodiment of a connector comprises a connection socket 1 according to the third embodiment of FIG. 8 as well as a connecting plug 2 according to the second embodiment of FIG. 9. The connection socket 1 is introduced into a cylindrical recess in the base plate 3, this cylindrical recess being implemented as a blind hole. In this embodiment, the pressure surface 14 is located on the side of the base region 12 facing upwards in the illustration. The pressure surface 14 extensively abuts on the bottom of the blind hole in the base plate 3. A mounting component B is guided through the securing element 13 implemented as a mounting aperture and connected to the support 5. Here, the mounting component B is also implemented as a screw which is screwed into a female thread in the support 5. The mounting component B pulls the connection socket 1 towards the support 5 and, in the process, clamps the interposed base plate 3 to the support 5. Owing to the large contact surface between the pressure surface 14 and the base plate, a stable connection in which the surface pressure between the connecting sleeve 1 and the base plate 3 is low is ensured in this embodiment as well. On the side of the cover plate 4, the connecting plug 2 is connected to the cover plate 4 via an adapter 6 like in the embodiment shown in FIG. 6. The illustration in FIG. 10 shows the connected state in which the protrusions 22121 of the latching elements 2212 are introduced into the undercut 15 and these elements establish a positive connection there which fixes the connecting plug 2 to the connection socket 1 in a direction parallel to the plug axis SA and to the connection axis VA. Like in the embodiment of FIG. 6, the fixation surfaces 22123 and the support surface 151 abutting on each other are also oriented so that they are inclined with respect to the connection axis VA and the plug axis SA in the embodiment of FIG. 10. Owing to this inclination of the surfaces, the bending arms 221 are radially deformed towards the connection axis VA when a tractive force is applied to the cover plate 4 in a direction away from the base plate 3, and finally the positive connection of the connection socket 1 to the connecting plug 2 is released like in the embodiment of FIG. 6. For establishing the shown connected state, the mating surfaces 22122 and the insertion surface 16 disposed on the connecting protrusion 18 are also brought in contact with each other, and then a pressure force in the direction of the base plate 3 is applied to the cover plate 4 in this embodiment. In this way, the connector 100 can be transferred from the separated to the shown connected state. Therefore, the cover plate 4 and the base plate 3 can also be separated from each other and connected to each other by applying forces perpendicular to the surface of the cover plate 4 in the embodiment illustrated in FIG. 10. Like in the embodiment illustrated in FIG. 6, the connection socket 1, on the one hand, fulfils the function of a connecting element in the scope of the connector 100 and, on the other hand, the function of a connecting element by means of which the cover plate 3 is securely and resiliently and yet detachably connected to the support 5 here. Apart from that, the description with reference to FIG. 6 is made reference to with regard to the properties and advantages of the components illustrated in FIG. 10.

FIG. 11 shows a perspective view of a fourth embodiment of a connection socket 1 according to the invention. The embodiment illustrated in FIG. 11, in portions, has a design which is identical or at least similar to the first embodiment of FIGS. 1 and 2. In contrast to the first embodiment, the fourth embodiment does not include a collar 17. Instead, the pressure surface 14 is implemented as a surface of the casing 11 disposed adjacent to the outer casing surface. The pressure surface 14 is oriented perpendicular to the connection axis VA and disposed on a shoulder which is provided on the outer casing surface of the casing 11. The pressure surface 14 is formed by a planar, ring-shaped surface which extends in the circumferential direction around the connection axis VA. Here, the pressure surface 14 is set back with respect to the front surface of the base region 12 facing downwards in the illustration. When a connection socket 1 according to the fourth embodiment is to be introduced into a base plate 3 a recess having a cylindrical design and a diameter which is equal to or slightly larger than the outer diameter of the cylindrical casing 11 is incorporated in the base plate 3. However, the recess in the base plate 3 has a shoulder implemented so that it is complementary in shape to the pressure surface 14 on its side facing the support 5. In a connection, the pressure surface 14 of the connecting sleeve 1 will then abut on the shoulder in the recess in the base plate 3. In the illustrated embodiment, the undercut 15 is disposed in the casing 11 but differs from the embodiment of FIGS. 1 and 2 in its shape. This difference can be seen in FIG. 12.

FIG. 12 shows a cross-sectional view of a fourth embodiment of a connection socket 1 according to the invention. In the cross-sectional view, the fourth embodiment of a connection socket 1 of FIG. 11 can be seen, the connection axis VA being located in the sectional plane. In the cross-sectional view, it can be seen that the undercut 15 is delimited by a curved inner wall of the casing 11. Therefore, the support surface 151 also has a curved design in this embodiment. A connecting plug 2 provided for the connection to the shown embodiment comprises a latching element 2212 designed complementary in shape corresponding to the shape of the undercut 15. In this embodiment, the insertion surface 16 is conical in shape. Between the insertion surface 16 and the undercut 15, a cylindrically shaped portion having a constant diameter is disposed. In the cross-sectional view, it can be clearly seen that the pressure surface 14 extends around the connection axis VA in the circumferential direction and is disposed on a shoulder in the casing 11. The securing element 13 is implemented as a mounting aperture. In this embodiment, the securing element 13 including the adjoining force introduction surface 131 projects beyond the adjacent base region 12 in the direction of the connection axis VA.

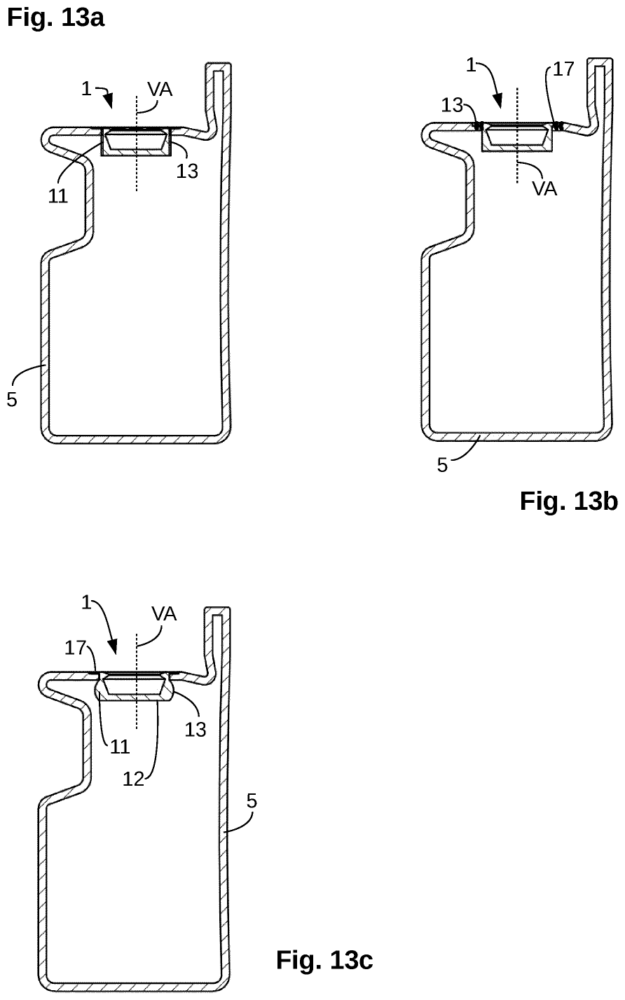

FIG. 13 shows three cross-sectional views of a support 5 together with a mounted connection socket 1. Here, the support 5 is formed by a steel profile implemented so that it is hollow inside. Such a support may be, for example, a formwork frame of a formwork panel for producing building parts. In FIG. 13, three different alternatives of connecting a connection socket 1 to the support 5 can be seen. In the illustration, the connection socket 1 is directly installed in the support 5, respectively. Alternatively, analogous to the embodiments of FIGS. 6 and FIG. 11, also a base plate 3 may be mounted between the connection socket 1 and the support 5. In each of the three views 13a to 13c, the support respectively extends perpendicular to the plane of the drawing. The connection axis VA of the connecting sleeve is respectively located in the sectional plane.

In FIG. 13a, a fifth embodiment of a connection socket 1 can be seen. In this fifth embodiment, the securing element 13 of the connection socket 1 is implemented as a male thread which is disposed on the outer surface of the casing 11 facing away from the connection axis VA. This male thread is screwed into a female thread cut into the surface of the support 5 facing upwards. In this embodiment, no other mounting component B is required. In the interior of the connection socket 1, for example, in the receptacle 111, wrench faces may be provided which can be brought in contact with a tool to be capable of screwing the connection socket 1 into the support 5 with an increased torque.

FIG. 13b shows a sixth embodiment of a connection socket 1. In this sixth embodiment, the connecting element 13 of the connection socket 1 is formed by welding or adhesion between the collar 17 and the adjacent surface of the support 5. This securing option is particularly easy to produce. In a case in which the connection socket 1 is made of a plastic material it can be simply glued to an opening in the support 5. In a case in which the connection socket 1 and the support 5 are made of metallic materials, also a weld connection can be established between the two components.

FIG. 13C shows a seventh embodiment of a connection socket. In this embodiment, the connection socket 1 is connected to the support 5 by riveting. To this end, the connection socket 1 was first introduced through a cylindrical opening in the side in the support 5 facing upwards. Then, the connection socket 1 was compressed in the interior of the support 5 so that the originally cylinder-shaped outer surface of the casing 1 has a permanent curvature towards the outside. The casing 11 was therefore plastically deformed and compressed in a direction parallel to the connection axis VA during riveting. With this deformation, a positive connection between the connection socket 1 and a wall of the support 5 was established which fixes the connection socket 1 relative to the support 5. For producing the compression or riveting, associated tools may be brought in contact with the base region 12 and the collar 17. For this embodiment, it is recommendable to produce the connection socket 1 from a plastically deformable material, for example, a metal.

### LIST OF REFERENCE NUMERALS

1 Connection socket

11 Casing

111 Receptacle

12 Base region

13 Securing element

131 Force introduction surface

14 Pressure surface

15 Undercut

151 Support surface

16 Insertion surface

17 Collar

18 Connecting protrusion

2 Connecting plug

21 Base

22 Bending portion

221 Bending arm

2211 Bending element

2212 Latching element

22121 Protrusion

22122 Mating surface

22123 Fixation surface

23 Interior bending space

3 Base plate

4 Cover plate

5 Support

6 Adapter

VA Connection axis

SA Plug axis

B Mounting component

1. A connection socket for use in a connector comprising:
a casing which extends along a connection axis at least in some regions and which extends in the circumferential direction about the connection axis at least in some regions, wherein a receptacle is disposed in the interior of the casing,
a base region which is connected to the casing or is part of the casing and which extends perpendicular to the connection axis at least in some regions, wherein the base region delimits the connection socket in the direction of the connection axis on one side,
at least one securing element which is disposed on or in the casing or on or in the base region,
at least one pressure surface which extends in the radial direction to the connection axis, wherein the pressure surface forms a front surface of the connection socket in the direction of the connection axis or projects beyond the front surface of the connection socket disposed on the base region in the radial direction to the connection axis,
at least one undercut which forms a cavity in the interior of the casing, wherein the undercut is delimited by elements of the connection socket projecting in the radial direction to the connection axis and adjoining the undercut on two opposite sides in the direction of the connection axis, and the undercut is open in some regions in the radial direction to the connection axis.

2. The connection socket according to claim 1, wherein at least one insertion surface is provided which extends in the radial direction to the connection axis and, at least in sections, is inclined with respect to the connection axis, and which is oriented towards the side of the connection socket facing away from the base region in the direction of the connection axis.

3. The connection socket according to claim 1, wherein the casing has a casing surface oriented away from the connection axis which forms the pressure surface.

4. The connection socket according to claim 1, wherein the pressure surface is formed by a surface of the base region oriented perpendicular to the connection axis, and/or the pressure surface is disposed on a collar, wherein the collar is disposed on an outer surface of the casing facing away from the connection axis and extends in a direction radially away from the connection axis.

5. The connection socket according to claim 4, wherein the pressure surface is disposed on a side of the collar facing the base region and is oriented perpendicular to the connection axis or at an acute angle to the connection axis in a direction away from the base region, and/or the collar adjoins the casing on its side located opposite of the base region in the direction of the connection axis.

6. The connection socket according to claim 1, wherein the securing element is implemented as a mounting aperture which extends through the base region and is disposed so that it is coaxial to the connection axis.

7. The connection socket according to claim 1, wherein the undercut is disposed on the inner side of the casing oriented towards the connection axis and forms a subsection of the receptacle, and/or the undercut is disposed between the base region and the end of the casing facing away from the base region in the direction of the connection axis.

8. The connection socket according to claim 1, wherein the undercut has at least one support surface oriented at an acute angle to a plane perpendicular to the connection axis on its side facing away from the base region in the direction of the connection axis.

9. The connection socket according to claim 1, wherein a connecting protrusion is provided which, starting from the base region, projects into the receptacle in the interior of the casing in the direction of the connection axis, and the undercut and/or the insertion surface are disposed on this connecting protrusion, wherein the connecting protrusion is preferably disposed so that it is coaxial to the connection axis.

10. The connection socket according to claim 1, wherein the insertion surface and the support surface of the undercut are disposed adjacent to each other and particularly connected to each other by a rounded transition area.

11. A connector comprising a connection socket according to claim 1 and a connecting plug, wherein the connecting plug comprises:
a base which carries the other elements of the connecting plug,
at least one bending portion which comprises at least one elastically deformable bending arm, wherein the bending arm, starting from the base, extends parallel to a plug axis,
at least one interior bending space which, at least in sections, is enclosed by the bending portion and which, on its side facing away from the base in the direction of the plug axis, is implemented so that it is open, and wherein the plug axis extends through the interior bending space,
wherein the bending arm comprises a bending element connected to the base which is designed so that it is elastically deformable in a radial direction to the plug axis, and wherein the bending arm comprises a latching element which is connected to the bending element on its side facing away from the base, wherein the latching element has a protrusion which projects beyond the bending element in the radial direction to the plug axis, and wherein the latching element has at least one mating surface which extends in the radial direction to the plug axis and, at least in sections, is inclined with respect to the plug axis, and which is oriented towards the side of the connecting plug facing away from the base in the direction of the plug axis;
wherein, in a connected state of the connector, the bending portion of the connecting plug, at least in sections, is introduced into the receptacle of the connection socket, wherein the protrusion of the latching element, at least in sections, in is introduced into and positively connected to the undercut, and a fixation surface disposed on the protrusion abuts on the support surface.

12. The connector according to claim 11, wherein the latching element has the fixation surface which, at least in sections, has a planar or conical design on its side facing away from the mating surface in the direction of the plug axis.

13. A secured double plate comprising a base plate and a cover plate which are oriented parallel to each other and, at least in sections, abut on each other, wherein the base plate and the cover plate are connected to each other by at least one connector according to claim 11, and at least one support,
wherein the connection socket is introduced into the base plate, and the connecting plug is connected to and, at least in sections, projects beyond the cover plate,
and wherein the base plate is connected to the support disposed on the side of the base plate facing away from the cover plate by the connection socket, wherein the pressure surface abuts on a surface of the base plate facing the cover plate, and the securing element connects, particularly non-positively connects the connection socket to the support.

14. The secured double plate according to claim 13, wherein the cover plate has a functional surface facing away from the base plate, and the cover plate is separable from the base plate by releasing the connector, wherein the connection between the cover plate and the base plate is releasable by applying a force which acts parallel to the connection axis and is directed away from the base plate.

15. A method for securing at least two plates to a support using at least one connector according to claim 11 comprising the steps of:
securing a base plate to a support, wherein the pressure surface of the connecting sleeve is placed on a surface of the base plate, and the securing element of the connecting sleeve is connected to the support, wherein, in the end of process step A), the base plate is non-positively and/or positively connected to the support by the connection socket,
securing a cover plate to the combination of the base plate and the support, wherein a connecting plug is secured to a surface of the cover plate, and the connecting plug is inserted into the connection socket connected to the base plate, and the connector is therefore transferred into the connected state.

16. The connection socket according to claim 3, wherein the pressure surface, at least in sections, is implemented so that it is conical or spherical, and/or the casing has a casing surface oriented away from the connection axis, and the pressure surface projects beyond the casing towards the inside or towards the outside in the radial direction to the connection axis.

17. The connection socket according to claim 9, wherein the connecting protrusion is disposed so that it is coaxial to the connection axis.
